(19) United States
(12) Patent Application Publication
(10) Pub. No.: US 2023/0108887 A1
(43) Pub. Date: Apr. 6, 2023

(54) METHOD FOR PREPARING TITANIUM-RESIN ASSEMBLY AND TITANIUM TREATMENT SOLUTION FOR SAME

(71) Applicant: PLASTAL CO., LTD., Gyeonggi-do (KR)

(72) Inventors: Mu Chang Sung, Incheon (KR); Jae Ik Kim, Gyeonggi-do (KR); Jae Hwa Kim, Seoul (KR); Sung Ho Hong, Incheon (KR)

(21) Appl. No.: 17/801,172

(22) PCT Filed: Jun. 22, 2021
(86) PCT No.: PCT/KR2021/007779

§ 371 Date: Aug. 19, 2022

(30) Foreign Application Priority Data
Jul. 7, 2020 (KR) 10-2020-0083290

(51) Int. Cl. B29C 45/14; C23F 1/26; C23F 1/38

(52) U.S. Cl. CPC B29C 45/14311; C23F 1/26; C23F 1/38; B29C 2045/14868; B29K 2705/08

(57) ABSTRACT

The present disclosure provides a method for preparing a titanium-resin assembly for improving the adhesion strength between a substrate containing titanium and a resin, which includes: a first pore formation step of immersing a substrate comprising titanium in a first solution and forming pores in the substrate by etching the same; a second pore formation step of immersing the substrate having pores formed in the first pore formation step in a second solution and forming another pores by etching the same; an electrolysis step of immersing the substrate that has undergone the second pore formation step in an electrolytic solution and conducting electrolysis; and a molding step of joining the substrate with a polymer resin and conducting injection molding, wherein the first solution is an alkaline solution with a pH>7 and the second solution is an acidic solution with a pH<7.

### TECHNICAL FIELD

The present disclosure relates to a method for preparing a titanium-resin assembly and a titanium treatment solution for the same. More particularly, it relates to a method for preparing a titanium-resin assembly, which has superior adhesion strength between titanium and a resin and superior tensile strength, and a titanium treatment solution for the same.

### BACKGROUND ART

Recently, weight reduction of products is an important issue in various industrial fields including the automobile industry and, therefore, efforts are being made to replace heavy metals with light materials. In this regard, the technology of joining metals with light plastic polymer resins is being developed.

With the development of technology for weight reduction, metal-polymer resin assemblies obtained by integrating metals such as aluminum, iron, etc. with plastics formed from polymer resins are used in various industrial fields. The metal-polymer resin assemblies have been applied to airplane parts, housings of secondary batteries, etc. and recently are being applied a lot also to the exterior parts of cell phones, etc.

As such a metal, titanium is used in airplanes, spaceships, etc. because it is lighter than steel by 43% and 2 times stronger than aluminum alloy. In addition, it is used in seawater desalination or shipbuilding applications because it has very strong corrosion resistance to several corrosives.

The titanium-polymer resin assembly is generally prepared by joining titanium with a plastic member formed from a polymer resin, or through insert injection molding after inserting titanium in a mold.

However, because the adhesion strength between titanium and the polymer resin is insufficient in general, there is a need of the development of a technology for ensuring sufficient adhesion strength between titanium and the polymer resin in the titanium-polymer resin assembly.

### DISCLOSURE OF THE INVENTION

### Technical Problem

The present disclosure is directed to providing a method for preparing a titanium-resin assembly, which has superior adhesion strength between titanium and a polymer resin, and a titanium treatment solution for the same.

### Technical Solution

The present disclosure provides a method for preparing a titanium-resin assembly, which includes: a first pore formation step of immersing a substrate containing titanium in a first solution and forming pores in the substrate by etching the same; a second pore formation step of immersing the substrate having pores formed in the first pore formation step in a second solution and forming another pores by etching the same; an electrolysis step of immersing the substrate that has undergone the second pore formation step in an electrolytic solution and conducting electrolysis; and a molding step of joining the substrate with a polymer resin and conducting injection molding, wherein the first solution is an alkaline solution with a pH>7 and the second solution is an acidic solution with a pH<7.

The present disclosure also provides a method for preparing a titanium-resin assembly, wherein the first solution includes at least one of sodium hydroxide, potassium hydroxide, sodium bicarbonate, sodium tetraborate and hydrogen peroxide, and the second solution includes at least one of nitric acid, hydrochloric acid, hydrofluoric acid, hydrosilicofluoric acid, ammonium bifluoride, sodium fluoride, methanesulfonic acid and hydrogen peroxide.

The present disclosure also provides a method for preparing a titanium-resin assembly, wherein the electrolytic solution includes at least one of oxalic acid (C₂H₄O₄), ammonium sulfate (H₈N₂O₄S), sodium sulfate (Na₂SO₄), sodium thiosulfate (Na₂S₂O₃), a chelating agent and sulfuric acid (H₂SO₄) and distilled water.

The present disclosure also provides a method for preparing a titanium-resin assembly, which further includes, between the second pore formation step and the electrolysis step, a step of activating the substrate by immersing the substrate in a nitric acid solution.

The present disclosure also provides a method for preparing a titanium-resin assembly, wherein the etching in the first pore formation step and the second pore formation step is conducted for 30-300 seconds.

The present disclosure also provides a method for preparing a titanium-resin assembly, wherein the etching in the first pore formation step and the second pore formation step is conducted at 20-80° C.

The present disclosure also provides a method for preparing a titanium-resin assembly, wherein the electrolysis step is performed at 5-80° C. for 180-3600 seconds.

The present disclosure also provides a method for preparing a titanium-resin assembly, wherein the electrolysis step is performed at a constant voltage of 1-50 V.

### Advantageous Effects

Because a method of printing nanoparticles with a uniform surface of the present disclosure uses simple evaporation acceleration without adding an organic material or internal liquid flow, the method may be applied without restrictions on a size and a constituent material of nanoparticles. Also, because a chemically programmed substrate may use various methods such as masked UV-ozone, various types of particle arrays may be formed.

Because a method of printing multi-nanoparticles of the present disclosure may fabricate solution-based nanoparticles as a film with a uniform surface by controlling an evaporation function, the method may be applied to various stacked solution process-based devices. Also, evaporation dynamics control may be applied to other solution processing technologies such as inkjet printing to fabricate uniform surface patterns for general purposes.

Because a process of fabricating a multi-nanoparticle array of the present disclosure does not require both a polymer transfer medium used in transfer printing and a radical used in optical patterning, optical and electrical damage to used particles and a target substrate does not occur, and thus, the process may be applied to, for example, a quantum dot light-emitting diode (QLED) using an organic material thin film as a device component.

A technology provided by the present disclosure is a technology for configuring a low-cost, large-area nanoparticle array and non-destructively printing the nanoparticle array on various substrates. When the technology is applied to fabricate next-generation electronic equipment that may use a printing process as an advantage, economic effects may be achieved by improving the performance of the equipment or minimizing the fabrication cost.

### Advantageous Effects

According to a method for preparing a titanium-resin assembly and a titanium treatment solution for the same of the present disclosure, a titanium-resin assembly with improved adhesion strength between titanium and a polymer resin and superior tensile strength may be prepared.

### BRIEF DESCRIPTION OF THE DRAWINGS

FIG. 1 shows a flow diagram of a method for preparing a titanium-resin assembly according to an exemplary embodiment of the present disclosure.

FIG. 2 shows an SEM image showing that first pores are formed on the surface of a substrate containing titanium in a first pore formation step (S10).

FIG. 3 shows an SEM image showing that second pores finer than first pores formed on the surface of a substrate containing titanium are formed in a second pore formation step (S20).

FIG. 4 shows an SEM image showing that a coating layer including fine protrusions are formed on the surface of a substrate containing titanium having pores formed in an electrolysis step (S30).

FIG. 5 shows a titanium sample and a surface-treated titanium substrate of Example 1.

### BEST MODE FOR CARRYING OUT THE INVENTION

Exemplary embodiments of the present disclosure will now be described in detail referring to the attached drawings so that those having ordinary knowledge in the art to which the present disclosure belongs can easily carry out the present disclosure. However, the present disclosure may be embodied in various different forms without being limited to the described embodiments.

Unless defined otherwise, all the technical and scientific terms used in the present specification have the meaning commonly understood by those skilled in the art to which the present disclosure belongs. When the meanings are contradictory, the definition in the present specification will take priority. Appropriate methods and materials are described in the present specification although those similar to the methods and materials described in the present specification may be used for carrying out or testing the present disclosure.

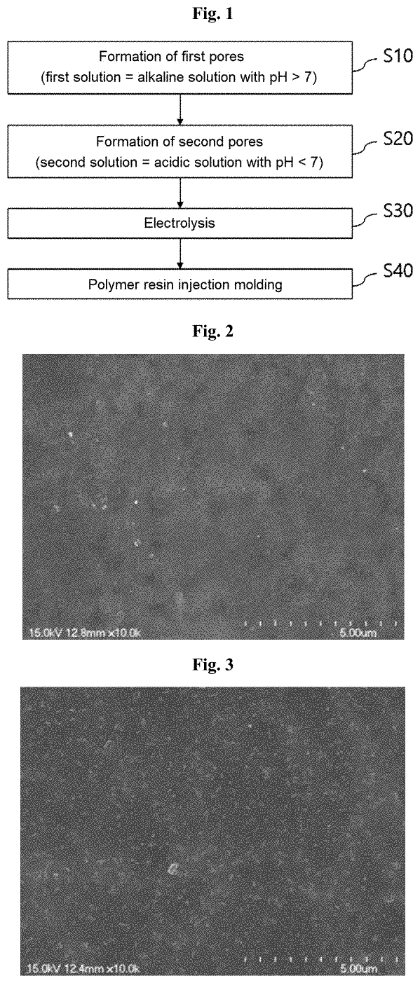

Hereinafter, a method for preparing a titanium-resin assembly and a titanium treatment solution for the same according to an exemplary embodiment of the present disclosure are described in detail referring to FIG. 1.

FIG. 1 shows a flow diagram of a method for preparing a titanium-resin assembly according to an exemplary embodiment of the present disclosure.

The method for preparing a titanium-resin assembly according to an exemplary embodiment of the present disclosure includes a first pore formation step (S10), a second pore formation step (S20), an electrolysis step (S30) and a polymer resin injection molding step (S40).

Hereinafter, each step is described in detail.

First, the first pore formation step (S10) is performed wherein a substrate containing titanium is immersed in a first solution to form pores in the substrate.

The first pore formation step (S10) is a step for forming first pores on the surface of a substrate containing titanium.

The first pore formation step (S10) may be performed by immersing the substrate containing titanium in the first solution and then etching the same.

In an exemplary embodiment of the present disclosure, the first solution may contain at least one of sodium hydroxide (NaOH), potassium hydroxide (KOH), sodium bicarbonate (NaHCO₃), sodium tetraborate (Na₂B₄O₇) and hydrogen peroxide (H₂O₂).

The first solution may contain 5-200 g/L of sodium hydroxide, 5-200 g/L of potassium hydroxide, 5-200 g/L of sodium bicarbonate, 5-80 g/L of sodium tetraborate and 5-200 g/L of hydrogen peroxide.

FIG. 2 shows an SEM image showing that first pores are formed on the surface of the substrate containing titanium in the first pore formation step (S10).

Referring to FIG. 2, first pores may be formed uniformly on the surface of the substrate containing titanium when the first solution of the aforesaid contents is used.

The first solution may be an alkaline solution with a pH>7. Within the above pH range, first pores may be formed uniformly on the substrate containing titanium because uniform and stable etching is possible. On the contrary, if the first solution has a pH≤7, first pores cannot be formed due to decreased reactivity between the first solution and titanium.

In addition, in the first pore formation step (S10), the etching may be specifically conducted for 30-300 seconds at 20-80° C. Within the time and temperature ranges, intact first pores may be formed completely and, thus, the adhesion strength between the titanium alloy and the polymer resin can be improved.

Although not shown in the figure, a degreasing process of removing contaminants such as oily substances present on the surface of the substrate containing titanium using a degreasing solution together with sonication may be performed, if necessary, before performing the first pore formation step (S10).

The second pore formation step (S20) may be performed by immersing the substrate containing titanium having pores formed in the first pore formation step (S10) in a second solution. This step is for forming second pores finer than the first pores formed in the substrate containing titanium.

The second pore formation step (S20) may be performed by immersing the substrate containing titanium having pores formed in the first pore formation step (S10) in the second solution and etching the same.

In an exemplary embodiment of the present disclosure, the second solution may contain at least one of nitric acid (HNO₃), hydrochloric acid (HCl), hydrofluoric acid (HF), hydrosilicofluoric acid (H₂SiF₆), ammonium bifluoride (NH₄HF₂), sodium fluoride (NaF), methanesulfonic acid (CH₃SO₃H) and hydrogen peroxide (H₂O₂).

The second solution may contain 5-200 g/L of nitric acid, 5-200 g/L of hydrochloric acid, 5-200 g/L of hydrofluoric acid, 5-200 g/L of hydrosilicofluoric acid, 5-200 g/L of ammonium bifluoride, 5-200 g/L of sodium fluoride, 5-200 g/L of methanesulfonic acid and 5-200 g/L of hydrogen peroxide.

FIG. 3 shows an SEM image showing that second pores finer than first pores formed on the surface of the substrate containing titanium are formed in the second pore formation step (S20).

Referring to FIG. 3, finer second pores may be formed uniformly on the surface of the substrate containing titanium having the first pores formed when the second solution of the above-described contents is used.

That is to say, according to the present disclosure, first pores of grain boundary size are formed on the surface of the substrate containing titanium in the first pore formation step (S10) and then finer second pores are formed on the first pores of grain boundary size that have been formed on the surface of the substrate containing titanium in the second pore formation step (S20) so as to improve adhesion strength to the polymer resin.

The second solution may be an acidic solution with a pH<7. Within the above-described pH range, the second pores may be formed uniformly because uniform and stable etching is possible on the surface of the substrate containing titanium. Otherwise, if the pH of the second solution is 7 or higher, the second pores may not be formed due to decreased reactivity between the second solution and titanium.

In addition, the etching in the second pore formation step (S20) may be specifically performed at 20-80° C. for 30-300 seconds. When the etching time and temperature are within the above-described ranges, intact second pores may be formed completely and the adhesion strength between the titanium alloy and the polymer resin may be improved.

Both the first pore formation step (S10) and the second pore formation step (S20) may be performed at 20-80° C. for 30-300 seconds.

When the etching of the substrate containing titanium is conducted within the above-described temperature and time ranges, the adhesion strength to the polymer resin may be maximized because pores can be formed uniformly.

Next, the electrolysis step (S30) is performed for the substrate containing titanium that has passed through the first pore formation step (S10) and the second pore formation step (S20).

Although not shown in the figure, after the first pore formation step (S10) and the second pore formation step (S20) and before performing the electrolysis step (S30), the substrate containing titanium that has passed through the first pore formation step (S10) and the second pore formation step (S20) may be activated by immersing in an aqueous nitric acid (HNO₃) solution in order to maximize the efficiency of the electrolysis step (S30).

The electrolysis step (S30) may be performed by immersing the substrate containing titanium in an electrolytic solution. It is a step for forming a coating layer including fine protrusions on the surface of the substrate containing titanium with the pores formed.

In the electrolysis step (S30), electrolysis may be conducted in the electrolytic solution by using a metal as a positive electrode and using an insoluble electrode as a negative electrode. As the negative electrode, platinum, stainless steel, carbon, etc. may be used.

In an exemplary embodiment of the present disclosure, the electrolytic solution may contain at least one of oxalic acid (C₂H₄O₄), ammonium sulfate (H₈N₂O₄S), sodium sulfate (Na₂SO₄), sodium thiosulfate (Na₂S₂O₃), a chelating agent and sulfuric acid (H₂SO₄) and distilled water.

In particular, as will be described in detail in test examples, an electrolytic solution containing sulfuric acid and Ti-EDTA (Ti—C₁₀H₁₆N₂O₈) as a chelating agent is advantageous in terms of tensile strength and helium leakage.

The electrolytic solution may contain 5-50 g/L of oxalic acid, 5-50 g/L of ammonium sulfate, 5-50 g/L of sodium sulfate, 5-50 g/L of sodium thiosulfate, 1-100 g/L of Ti-EDTA and 5-500 g/L of sulfuric acid.

In addition, the electrolysis step (S30) may be performed at a constant voltage of 1-50 V and at 5-80° C. for 180-3600 seconds.

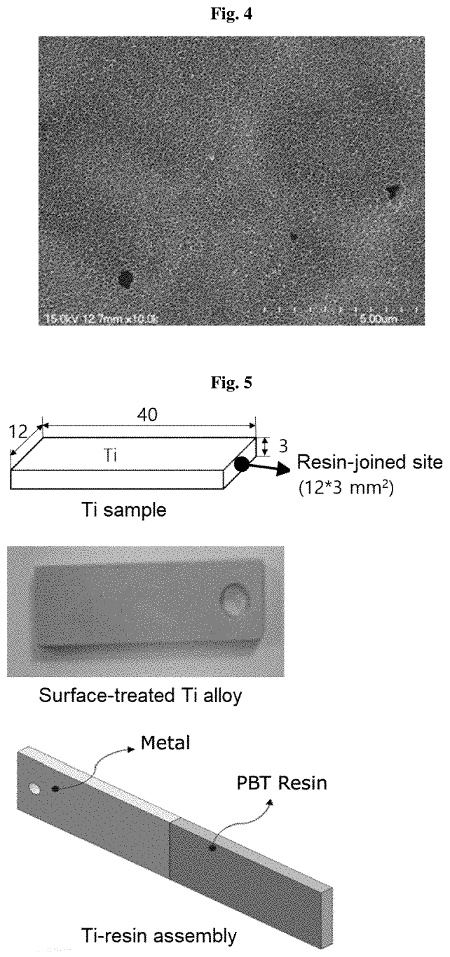

FIG. 4 shows an SEM image showing that a coating layer including fine protrusions are formed on the surface of the substrate containing titanium having pores formed in the electrolysis step (S30).

Referring to FIG. 4, the adhesion strength to the polymer resin may be maximized when the electrolysis of the substrate containing titanium is conducted within the above- described voltage, temperature and time ranges as a coating layer having uniform, fine protrusions is formed.

Next, the polymer resin injection molding step (S40) is performed for the substrate containing titanium that has passed through the electrolysis step (S30).

Although not shown in the figure, a drying step using hot air, etc. may be further performed after the electrolysis step (S30) and before the polymer resin injection molding step (S40) in order to prevent the corrosion of the surface of the substrate containing titanium by removing water on the surface of the substrate containing titanium, if necessary.

As the polymer resin, a liquid crystal polymer (LCP), polybutylene terephthalate (PBT), polyphenylene sulfide (PPS), polyphthalamide (PPA), polyethylene terephthalate (PET), polycarbonate (PC), polyimide (PI), polyaryletherketone (PAEK), polyetheretherketone (PEEK), etc. may be used. However, various polymer resins may be used without being limited thereto.

In the polymer resin injection molding step (S40), a titanium-polymer resin assembly may be prepared by disposing the substrate containing titanium in a mold and injection molding the polymer resin in the mold.

### Example 1

FIG. 5 shows a titanium sample, a surface-treated titanium substrate and a titanium-resin assembly of Example 1.

Referring to FIG. 5, a Ti Gr2 plate with a thickness of 3 mm was cut to prepare 20 samples with a size of 40×12×3 mm. After forming a hole with a size of 4 mm in the sample for installation on a rack for joining, the samples were installed using the holes. Then, after putting the rack in a mixture of 20% sodium bicarbonate, 20% sodium hexametaphosphate, 20% sodium silicate and 2% surfactant in distilled water at 30° C. and removing impurities on the surface by conducting ultrasonic washing for 30 seconds, the samples were washed with distilled water. After forming first pores by putting the washed samples in a mixture of 30% sodium hydroxide, 30% sodium tetraborate and 5% hydrogen peroxide in distilled water in a bubble stirrer at 70° C. and etching for 5 minutes, impurities generated during the etching were removed by washing with distilled water. After forming second pores by putting the washed samples for 30 seconds in a mixture of 25% hydrofluoric acid, 25% hydrochloric acid and 20% sulfonic acid in distilled water at 70° C., followed by activation of the surface of the samples by immersing in a 20% nitric acid solution, they were washed twice with distilled water. A surface-treated titanium substrate was prepared by putting the surface-activated titanium sample in a mixture of 40% sulfuric acid and 5% Ti-EDTA in distilled water at 60° C. and forming a coating layer by conducting electrolysis for 1200 seconds at a constant voltage of 5 V. Subsequently, a titanium-resin assembly was prepared by conducting injection molding for 5 seconds at a mold temperature of 170° C. and a nozzle temperature of 300° C. using Toray's PPS as a polymer resin and Woojin's TB series 120-ton horizontal injecting molding machine.

### Example 2

Joining was conducted in the same manner as in Example 1 except that 5% Ti-EDTA was not used in the mixture during the electrolysis.

### Example 3

Joining was conducted in the same manner as in Example 1 except that the second pores were not formed.

### Example 4

Joining was conducted in the same manner as in Example 1 except that the first pores were not formed.

### Test Example 1. Measurement of Tensile Strength

In order to investigate the adhesion strength between the titanium alloy and the cured polymer resin depending on the components of the electrolytic solution (a) and the formation of the first pores or second pores (b), tensile strength was measured at a speed of 3 mm/min using Time Group's WDW series UTM. The tensile strength measurement was repeated 10 times and then averaged.

The test result is shown in Table 1.

TABLE 1

| | | Tensile strength (MPa) | | | | | | | | | | | |
|---|---|---|---|---|---|---|---|---|---|---|---|---|---|
| | Processing | #1 | #2 | #3 | #4 | #5 | #6 | #7 | #8 | #9 | #10 | Mean | Note |
| Electrolytic | Degreasing + etching 1 + | 33.4 | 37.1 | 36.5 | 36.6 | 35.1 | 36.5 | 37.9 | 36.7 | 38.0 | 37.1 | 36.5 | Ex. 2 |
| solution | etching 2 + electrolysis | | | | | | | | | | | | |
| components (a) | (H₂SO₄) | | | | | | | | | | | | |
| | Degreasing + etching 1 + | 39.8 | 38.6 | 42.6 | 41.3 | 41.7 | 41.6 | 40.5 | 38.1 | 41.5 | 40.2 | 40.6 | Ex. 1 |
| | etching 2 + electrolysis | | | | | | | | | | | | |
| | (H₂SO₄ + Ti-EDTA) | | | | | | | | | | | | |
| | (WAT standard process) | | | | | | | | | | | | |
| Formation of | Degreasing + etching 1 + | 30.2 | 33.8 | 30.6 | 30.8 | 32.9 | 32.2 | 31.9 | 33.3 | 34.1 | 30.4 | 32.0 | Ex. 3 |
| first pores | electrolysis (H₂SO₄ + | | | | | | | | | | | | |
| or second | Ti-EDTA) | | | | | | | | | | | | |
| pores (b) | Degreasing + etching 2 + | 34.9 | 33.4 | 33.9 | 32.6 | 33.2 | 33.8 | 35.2 | 34.9 | 35.8 | 34.7 | 34.2 | Ex. 4 |
| | electrolysis (H₂SO₄ + | | | | | | | | | | | | |
| | Ti-EDTA) | | | | | | | | | | | | |
| | Degreasing + etching 1 + | 39.8 | 38.6 | 42.6 | 41.3 | 41.7 | 41.6 | 40.5 | 38.1 | 41.5 | 40.2 | 40.6 | Ex. 1 |
| | etching 2 + electrolysis | | | | | | | | | | | | |
| | (H₂SO₄ + Ti-EDTA) | | | | | | | | | | | | |
| | (WAT standard process) | | | | | | | | | | | | |

As shown in Table 1, the titanium-resin assemblies of Example 2 wherein the electrolytic solution contained sulfuric acid only and Examples 3-4 wherein one of the two pore formation steps was omitted showed lower tensile strength than the titanium-resin assembly of Example 1 wherein the electrolytic solution contained sulfuric acid and Ti-EDTA and both the two formation steps were performed.

### Test Example 2. Measurement of Helium Leakage

Helium leakage was measured in order to investigate the adhesion uniformity between the titanium alloy and the cured polymer resin. Pass was assigned when the helium leakage was 10⁻⁸ Pa·m³/s or less, and fail was assigned when the helium leakage exceeded 10⁻⁸ Pa·m³/s.

The test result is shown in Table 2.

TABLE 2

| | | Leakage (10 tests) | | |
|---|---|---|---|---|
| | Processing | Pass | Fail | Note |
| Electrolytic | Degreasing + etching 1 + | 1 | 9 | Ex. 2 |
| solution | etching 2 + electrolysis | | | |
| components (a) | (H₂SO₄) | | | |
| | Degreasing + etching 1 + | 10 | 0 | Ex. 1 |
| | etching 2 + electrolysis | | | |
| | (H₂SO₄ + Ti-EDTA) | | | |
| | (WAT standard process) | | | |
| Formation of | Degreasing + etching 1 + | 4 | 6 | Ex. 3 |
| first pores | electrolysis (H₂SO₄ + Ti- | | | |
| or second | EDTA) | | | |
| pores (b) | Degreasing + etching 2 + | 5 | 5 | Ex. 4 |
| | electrolysis (H₂SO₄ + Ti- | | | |
| | EDTA) | | | |
| | Degreasing + etching 1 + | 10 | 0 | Ex. 1 |
| | etching 2 + electrolysis | | | |
| | (H₂SO₄ + Ti-EDTA) | | | |
| | (WAT standard process) | | | |

As shown in Table 2, the pass ratio of helium leakage was 10%, for Example 2 wherein the electrolytic solution contained sulfuric acid only and 40% and 50%, respectively, for Examples 3 and 4 wherein one of the two pore formation steps was omitted. The titanium-resin assemblies according to Examples 2-4 showed decreased adhesion uniformity because helium leakage exceeded 10⁻⁸ Pa·m³/s as compared to Example 1 (helium leakage pass ratio: 100%) wherein the electrolytic solution contained sulfuric acid and Ti-EDTA and both the two formation steps were performed.

### Test Example 3. Measurement of Tensile Strength Depending on Etching Time

Tensile strength depending on etching time was measured to investigate the adhesion strength between the titanium alloy and the cured polymer resin depending on the formation of pores.

The test result is shown in Table 3.

TABLE 3

| | | Etching | Tensile strength (MPa) | | | | | | | | | | |
|---|---|---|---|---|---|---|---|---|---|---|---|---|---|
| | Processing | time | #1 | #2 | #3 | #4 | #5 | #6 | #7 | #8 | #9 | #10 | Mean |
| Tensile | Degreasing + etching 1 + | Etching 1 | 17.8 | 17.7 | 18.9 | 17.7 | 18.6 | 19.5 | 19.1 | 19.4 | 18.3 | 18.7 | 18.6 |
| strength | etching 2 + electrolysis | 0-29 sec | | | | | | | | | | | |
| depending | (H₂SO₄ + Ti-EDTA) | Etching 1 | 39.8 | 38.6 | 42.6 | 41.3 | 41.7 | 41.6 | 40.5 | 38.1 | 41.5 | 40.2 | 40.6 |
| on etching | (WAT standard process) | 30-300 sec | | | | | | | | | | | |
| time | | (standard | | | | | | | | | | | |
| | | process) | | | | | | | | | | | |
| | | Etching 1 | 28.8 | 27.1 | 27.4 | 26.5 | 27.8 | 26.5 | 26.1 | 26.9 | 26.3 | 27.8 | 27.1 |
| | | 301-600 sec | | | | | | | | | | | |
| | Degreasing + etching 1 + | Etching 2 | 14.5 | 14.1 | 14.9 | 15.8 | 13.5 | 14.8 | 15.3 | 15.3 | 14.8 | 14.3 | 14.7 |
| | etching 2 + electrolysis | 0-29 sec | | | | | | | | | | | |
| | (H₂SO₄ + Ti-EDTA) | Etching 2 | 39.8 | 38.6 | 42.6 | 41.3 | 41.7 | 41.6 | 40.5 | 38.1 | 41.5 | 40.2 | 40.6 |
| | (WAT standard process) | 30-300 sec | | | | | | | | | | | |
| | | (standard | | | | | | | | | | | |
| | | process) | | | | | | | | | | | |

| | |
|---|---|
| Etching 2 | Measurement was impossible due to dissolution of Ti |
| 301-600 sec | |

### Test Example 4. Measurement of Tensile Strength Depending on Etching Temperature

Tensile strength depending on etching temperature was measured to investigate the adhesion strength between the titanium alloy and the cured polymer resin depending on the formation of pores.

The result is shown in Table 4.

TABLE 4

| | | Etching | Tensile strength (MPa) | | | | | | | | | | |
|---|---|---|---|---|---|---|---|---|---|---|---|---|---|
| | Processing | temperature | #1 | #2 | #3 | #4 | #5 | #6 | #7 | #8 | #9 | #10 | Mean |
| Tensile | Degreasing + etching 1 + | Etching 1 | 21.9 | 20.0 | 17.1 | 19.9 | 20.1 | 22.1 | 17.8 | 17.6 | 18.4 | 19.5 | 19.4 |
| strength | etching 2 + electrolysis | 0-19° C. | | | | | | | | | | | |
| depending | (H₂SO₄ + Ti-EDTA) | Etching 1 | 39.8 | 38.6 | 42.6 | 41.3 | 41.7 | 41.6 | 40.5 | 38.1 | 41.5 | 40.2 | 40.6 |
| on etching | (WAT standard process) | 20-80° C. | | | | | | | | | | | |
| temperature | | (standard | | | | | | | | | | | |
| | | process) | | | | | | | | | | | |
| | | Etching 1 | 19.8 | 23.6 | 22.1 | 22.8 | 21.4 | 22.1 | 22.4 | 21.8 | 20.3 | 20.1 | 21.6 |
| | | 81-100° C. | | | | | | | | | | | |
| | Degreasing + etching 1 + | Etching 2 | 18.5 | 16.1 | 16.5 | 15.7 | 17.8 | 16.7 | 16.9 | 17.1 | 18.1 | 16.5 | 17.0 |
| | etching 2 + electrolysis | 0-19° C. | | | | | | | | | | | |
| | (H₂SO₄ + Ti-EDTA) | Etching 2 | 39.8 | 38.6 | 42.6 | 41.3 | 41.7 | 41.6 | 40.5 | 38.1 | 41.5 | 40.2 | 40.6 |
| | (WAT standard process) | 20-80° C. | | | | | | | | | | | |
| | | (standard | | | | | | | | | | | |
| | | process) | | | | | | | | | | | |

| | |
|---|---|
| Etching 2 | Measurement was impossible due to dissolution of Ti |
| 81-100° C. | |

As shown in Table 4, tensile strength was very low when the etching temperature of the first and second pore formation steps was low as 0-19° C. because the first and second pores were not formed completely. Conversely, when the etching temperature was high as 81-100° C., the tensile strength was decreased due to damage of the formed first pores. In contrast, when the etching temperature was 20-80° C., the tensile strength was high because the first and second pores were formed completely without damage. As described above, the adhesion strength between titanium and the resin can be improved when a mixture solution of sulfuric acid and Ti-EDTA is used as an electrolytic solution and both the first pore and second pore formation steps are performed in the method for preparing a titanium-resin assembly according to an exemplary embodiment of the present disclosure.

Although specific exemplary embodiments of the present disclosure have been described above, the scope of the present disclosure is not limited thereby but various changes and modifications to the basic concept of the present disclosure defined in the appended claims also belong to the scope of the present disclosure.

1. A method for preparing a titanium-resin assembly, comprising:
a first pore formation step of immersing a substrate comprising titanium in a first solution and forming pores in the substrate by etching the same;
a second pore formation step of immersing the substrate having pores formed in the first pore formation step in a second solution and forming another pores by etching the same;
an electrolysis step of immersing the substrate that has undergone the second pore formation step in an electrolytic solution and conducting electrolysis; and
a molding step of joining the substrate with a polymer resin and conducting injection molding,
wherein the first solution is an alkaline solution with a pH>7 and the second solution is an acidic solution with a pH<7.

2. The method for preparing a titanium-resin assembly of claim 1,
wherein the first solution comprises at least one of sodium hydroxide, potassium hydroxide, sodium bicarbonate, sodium tetraborate, and hydrogen peroxide,
wherein the second solution comprises at least one of nitric acid, hydrochloric acid, hydrofluoric acid, hydrosilicofluoric acid, ammonium bifluoride, sodium fluoride, methanesulfonic acid, and hydrogen peroxide.

3. The method for preparing a titanium-resin assembly of claim 1, wherein the electrolytic solution comprises:
at least one of oxalic acid (C₂H₄O₄), ammonium sulfate (H₈N₂O₄S), sodium sulfate (Na₂SO₄), sodium thiosulfate (Na₂S₂O₃), a chelating agent, and sulfuric acid (H₂SO₄); and
distilled water.

4. The method for preparing a titanium-resin assembly of claim 1, wherein the method for preparing a titanium-resin assembly further comprises, between the second pore formation step and the electrolysis step, a step of activating the substrate by immersing the substrate in a nitric acid solution.

5. The method for preparing a titanium-resin assembly of claim 1, wherein the etching in the first pore formation step and the second pore formation step is conducted for 30-300 seconds.

6. The method for preparing a titanium-resin assembly of claim 1, wherein the etching in the first pore formation step and the second pore formation step is conducted at 20-80° C.

7. The method for preparing a titanium-resin assembly of claim 1, wherein the electrolysis step is performed at 5-80° C. for 180-3600 seconds.

8. The method for preparing a titanium-resin assembly of claim 7, wherein the electrolysis step is performed at a constant voltage of 1-50 V.

9. A method for preparing a titanium-resin assembly, comprising:
a first pore formation step of immersing a substrate comprising titanium in a first solution and forming pores in the substrate by etching the same;
a second pore formation step of immersing the substrate having pores formed in the first pore formation step in a second solution and forming another pores by etching the same;
an activating step of immersing the substrate in a nitric acid solution;
an electrolysis step of immersing the substrate that has undergone the activating step in an electrolytic solution and conducting electrolysis; and
a molding step of joining the substrate with a polymer resin and conducting injection molding.

10. The method for preparing a titanium-resin assembly of claim 9,
wherein the first solution comprises at least one of sodium hydroxide, potassium hydroxide, sodium bicarbonate, sodium tetraborate, and hydrogen peroxide,
wherein the second solution comprises at least one of nitric acid, hydrochloric acid, hydrofluoric acid, hydrosilicofluoric acid, ammonium bifluoride, sodium fluoride, methanesulfonic acid, and hydrogen peroxide.

11. The method for preparing a titanium-resin assembly of claim 9, wherein the electrolytic solution comprises:
at least one of oxalic acid (C₂H₄O₄), ammonium sulfate (H₈N₂O₄S), sodium sulfate (Na₂SO₄), sodium thiosulfate (Na₂S₂O₃), a chelating agent, and sulfuric acid (H₂SO₄); and
distilled water.

12. The method for preparing a titanium-resin assembly of claim 9, wherein the etching in the first pore formation step and the second pore formation step is conducted for 30-300 seconds.

13. The method for preparing a titanium-resin assembly of claim 9, wherein the etching in the first pore formation step and the second pore formation step is conducted at 20-80° C.

14. The method for preparing a titanium-resin assembly of claim 9, wherein the electrolysis step is performed at 5-80° C. for 180-3600 seconds.

15. The method for preparing a titanium-resin assembly of claim 14, wherein the electrolysis step is performed at a constant voltage of 1-50 V.
